(19) United States
(12) Patent Application Publication
(10) Pub. No.: US 2011/0316858 A1
(43) Pub. Date: Dec. 29, 2011

(54) Apparatuses and Methods for Real Time Widget Interactions

(75) Inventors: Yuan-Chung Shen, Taipei City (TW); Cheng-Hung Ko, Taipei City (TW)

(73) Assignee: MEDIATEK INC., Hsin-Chu (TW)

(21) Appl. No.: 12/822,271

(22) Filed: Jun. 24, 2010

(51) Int. Cl. G06F 3/041; G06T 13/00; G06F 3/048

(52) U.S. Cl. 345/473; 715/765; 345/173; 715/769

(57) ABSTRACT

An electronic interaction apparatus is provided with a touch screen and a processing unit. The processing unit executes a first widget and a second widget, wherein the first widget generates an animation on the touch screen and modifies the animation in response to an operating status change of the second widget.

### BACKGROUND OF THE INVENTION

1. Field of the Invention

The invention generally relates to interaction between independent widgets, and more particularly, to apparatuses and methods for providing real time interaction between independent widgets in a presentation layer.

2. Description of the Related Art

To an increasing extent, display panels are being used for electronic devices, such as computers, mobile phones, media player devices, and gaming devices, etc., as human-machine interfaces. The display panel may be a touch panel which is capable of detecting the contact of objects thereon; thereby, providing alternatives for user interaction therewith, for example, by using pointers, styluses, fingers, etc. Generally, the display panel may be provided with a graphical user interface (GUI) for a user to view current statuses of particular applications or widgets, and the GUI is provided to dynamically display the interface in accordance with a selected widget or application. A widget provides a single interactive point for direct manipulation of a given kind of data. In other words, a widget is a basic visual building block associated with an application, which holds all the data processed by the application and provides available interactions on this data. Specifically, a widget may have its own functions, behaviors, and appearances.

Each widget that is built into electronic devices is usually used to implement distinct functions and further generate specific data in distinct visual presentations. That is, the widgets are usually executed independently from each other. For example, a news or weather widget, when executed, retrieves news or weather information from the Internet and displays it on the display panel, and a map widget, when executed, downloads map images of a specific area and displays it on the display panel. However, as the number and variety of widgets built into an electronic device increases, it is desirable to have an efficient, intuitive, and intriguing way of interactions between the independent widgets.

### BRIEF SUMMARY OF THE INVENTION

Accordingly, embodiments of the invention provide apparatuses and methods for real time widget interactions. In one aspect of the invention, an electronic interaction apparatus is provided. The electronic interaction apparatus comprises a touch screen and a processing unit. The processing unit executes a first widget and a second widget, wherein the first widget generates an animation on the touch screen and modifies the animation in response to an operating status change of the second widget.

In another aspect of the invention, another electronic interaction apparatus is provided. The electronic interaction apparatus comprises a touch screen and a processing unit. The processing unit detects a touch event on the touch screen, and executes a widget, wherein the widget generates an animation on the touch screen, and modifies the animation in response to the touch event.

In still another aspect of the invention, a real time interaction method executed in an electronic interaction apparatus with a touch screen is provided. The real time interaction method comprises the steps of executing a first widget and a second widget, wherein the first widget generates an appearance on the touch screen, and modifying, by the first widget, the appearance in response to an operating status change of the second widget.

In still another aspect of the invention, another real time interaction method for an electronic interaction apparatus with a touch screen is provided. The real time interaction method comprises the steps of executing a widget generating an appearance on the touch screen, detecting a touch event on the touch screen, and modifying, by the first widget, the appearance in response to the touch event.

Other aspects and features of the present invention will become apparent to those with ordinarily skill in the art upon review of the following descriptions of specific embodiments of the apparatus and methods for real time widget interactions.

### BRIEF DESCRIPTION OF DRAWINGS

The invention can be more fully understood by reading the subsequent detailed description and examples with references made to the accompanying drawings, wherein:

FIG. 1 is a block diagram of a mobile phone according to an embodiment of the invention;

FIG. 2 is a block diagram illustrating the software architecture of a widget system according to an embodiment of the invention;

FIGS. 3A to 3C show exemplary displays on the touch screen 16 according to an embodiment of the invention;

FIGS. 4A to 4C show exemplary displays on the touch screen 16 according to an embodiment of the invention;

FIG. 5A shows a schematic diagram of a click event with a signal s1 on the touch screen 16 according to an embodiment of the invention;

FIG. 5B shows a schematic diagram of a drag event with signals s2 to s4 on the touch screen 16 according to an embodiment of the invention;

FIG. 6 is a flow chart illustrating the real time interaction method for the mobile phone 10 according to an embodiment of the invention;

FIG. 7 is a flow chart illustrating another embodiment of the real time interaction method;

FIG. 8 is a flow chart illustrating still another embodiment of the real time interaction method;

FIG. 9 is a flow chart illustrating the real time interaction method for the mobile phone 10 according to still another embodiment of the invention; and

FIG. 10 is a flow chart illustrating the real time interaction method for the mobile phone 10 according to still another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

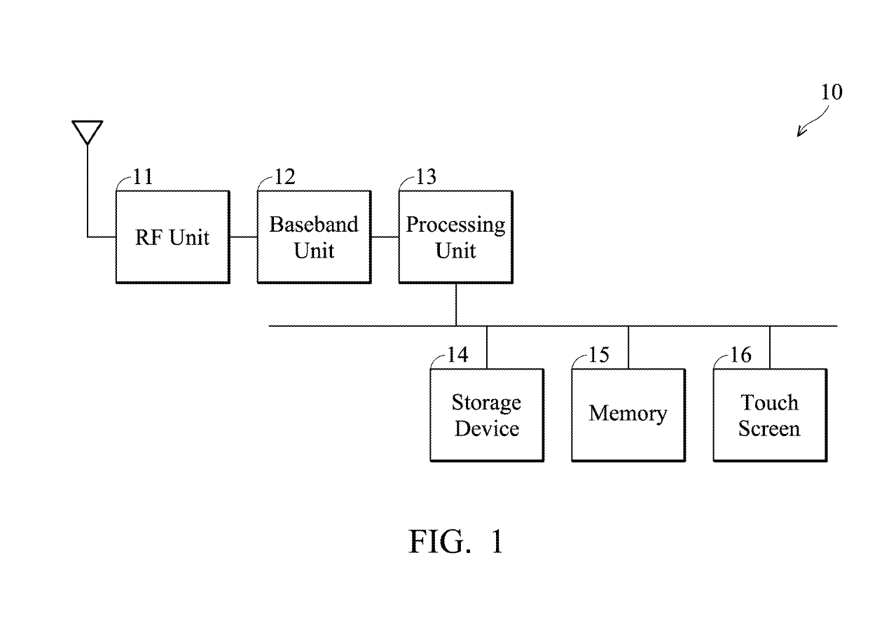

FIG. 1 is a block diagram of a mobile phone according to an embodiment of the invention. The mobile phone 10 is equipped with a Radio Frequency (RF) unit 11 and a Baseband unit 12 to communicate with a corresponding node via a cellular network. The Baseband unit 12 may contain multiple hardware devices to perform baseband signal processing, including analog to digital conversion (ADC)/digital to analog conversion (DAC), gain adjusting, modulation/demodulation, encoding/decoding, and so on. The RF unit 11 may receive RF wireless signals, convert the received RF wireless signals to baseband signals, which are processed by the Baseband unit 12, or receive baseband signals from the baseband unit 12 and convert the received baseband signals to RF wireless signals, which are later transmitted. The RF unit 11 may also contain multiple hardware devices to perform radio frequency conversion. For example, the RF unit 11 may comprise a mixer to multiply the baseband signals with a carrier oscillated in the radio frequency of the wireless communications system, wherein the radio frequency may be 900 MHz, 1800 MHz or 1900 MHz utilized in GSM systems, or may be 900 MHz, 1900 MHz or 2100 MHz utilized in WCDMA systems, or others depending on the radio access technology (RAT) in use. The mobile phone 10 is further equipped with a touch screen 16 as part of a man-machine interface (MMI). The MMI is the means by which people interact with the mobile phone 10. The MMI may contain screen menus, icons, text messages, and so on, as well as physical buttons, keypad and the touch screen 16, and so on. The touch screen 16 is a display screen that is sensitive to the touch or approximation of a finger or stylus. The touch screen 16 may be the resistive or capacitive type, or others. Users may manually touch, press, or click the touch screen to operate the mobile phone 10 with the indication of the displayed menus, icons or messages. A processing unit 13 of the mobile phone 10, such as a general-purposed processor or a micro-control unit (MCU), or others, loads and executes a series of program codes from a memory 15 or a storage device 14 to provide functionality of the MMI for users. It is to be understood that the introduced methods for real time widget interaction may be applied to different electronic apparatuses, such as portable media players (PMP), global positioning system (GPS) navigation devices, portable gaming consoles, and so on, without departing from the spirit of the invention.

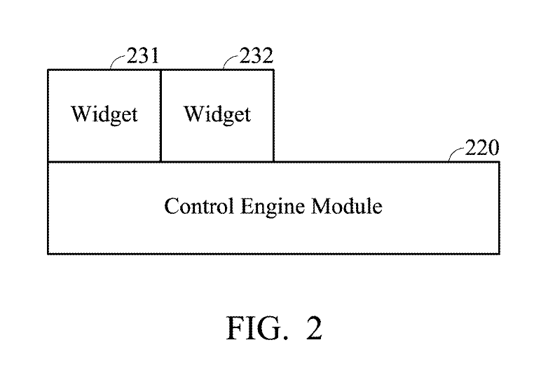

FIG. 2 is a block diagram illustrating the software architecture of a widget system according to an embodiment of the invention. The software architecture comprises a control engine module 220 providing a widget system framework for enabling a plurality of widgets, which is loaded and executed by the processing unit 13. The widget system framework functions as a hosting platform with necessary underlying functionalities for the operation of the widgets. Among the widgets, there are two or more widgets, such as widgets 231 and 232, each associated with a respective application, performing their own functions and having their own behaviors when enabled (also, may be referred to as initialized) by the control engine module 220. Unlike conventional independent widgets, the widgets 231 and 232 are capable of interacting with each other. To be more specific, the widget 231 may detect changes of the operating status of the widget 232, and further modify its own behavior of the respective application in response to the changed operating status of the widget 232. The operating statuses may contain an appearance attribute, such as being present or hidden, a displayed coordinate on the touch screen 16, displayed length and width, or others. In one embodiment, the control engine module 220 may provide the operating statuses of all widgets since all widgets are enabled to execute upon it. In order to detect an operating status change of the widget 232, the widget 231 may request the control engine module 220 for information concerning the operating status of the widget 232, and then determine whether the operating status of the widget 232 has changed. From a software implementation perspective, the control engine module 220 may, for example, obtain an identification indicator of the widgets 231 and 232 when the widgets 231 and 232 are created and registered to the control engine module 220, so that the control engine module 220 may keep track of the operating statuses of the registered widgets. The control engine module 220 may actively inform the widget 231 about the identification indicator of the widget 232 when the two widgets are functionally correlated. Accordingly, requests for the current operating statuses of the widget 232 may be periodically issued to the control engine module 220, and the control engine module 220 may retrieve the current operating status of the widget 232 and reply the operating status thereof to the widget 231. Another way to get operating status information is to invoke a method of the widget 232 or retrieve a public property of the widget 232. In another embodiment, the widget 232 may actively inform the widget 231 about the change of the operating status of the widget 232, to trigger the widget 231 to perform a corresponding operation. From a software implementation perspective, the widget 231 may subscribe an operating status change event provided by the widget 232. The subscription information may be kept in the control engine module 220. Once the current operating status of the widget 232 changes the widget 231 is notified with the change via the control engine module 220.

In addition to an operating status change of the widget 232, the widget 231 may further modify its own behavior of the respective application in response to the touch event on the touch screen 16. The touch screen 16 displays visual presentations of images or animations for the widgets 231 and 232. There may be sensors (not shown) disposed on or under the touch screen 16 for detecting a touch or approximation thereon. A touch screen 16 may comprise a sensor controller for analyzing data from the sensors and accordingly determining one or more touch events. The determination may be alternatively accomplished by the control engine module 110 while the sensor controller is responsible for repeatedly outputting sensed coordinates of one or more touches or approximations. The widget 231 may further modify its own behavior of the respective application in response to the touch event.

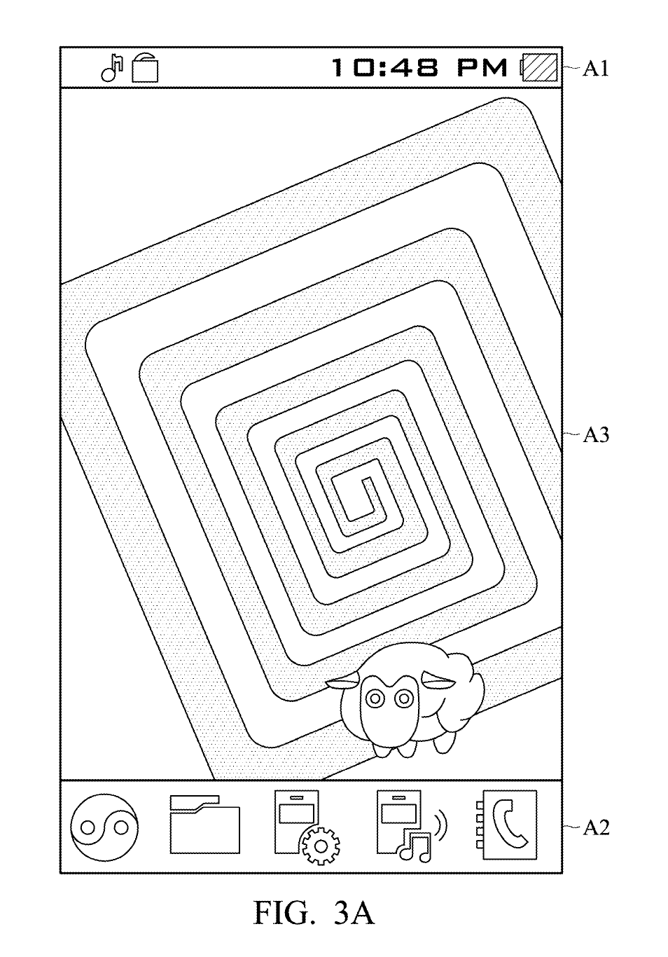

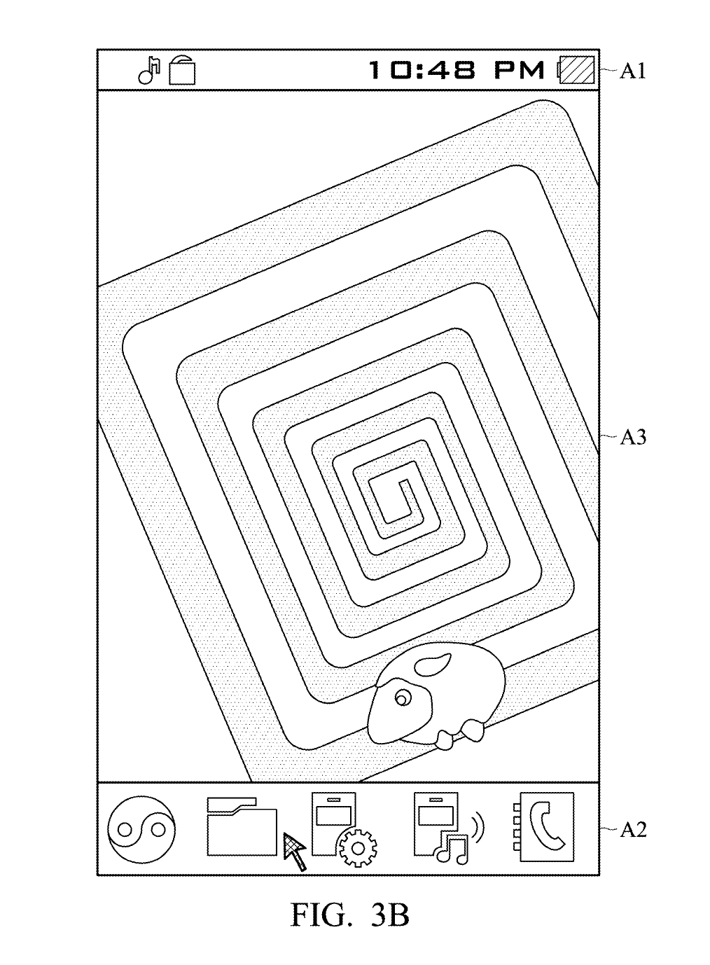

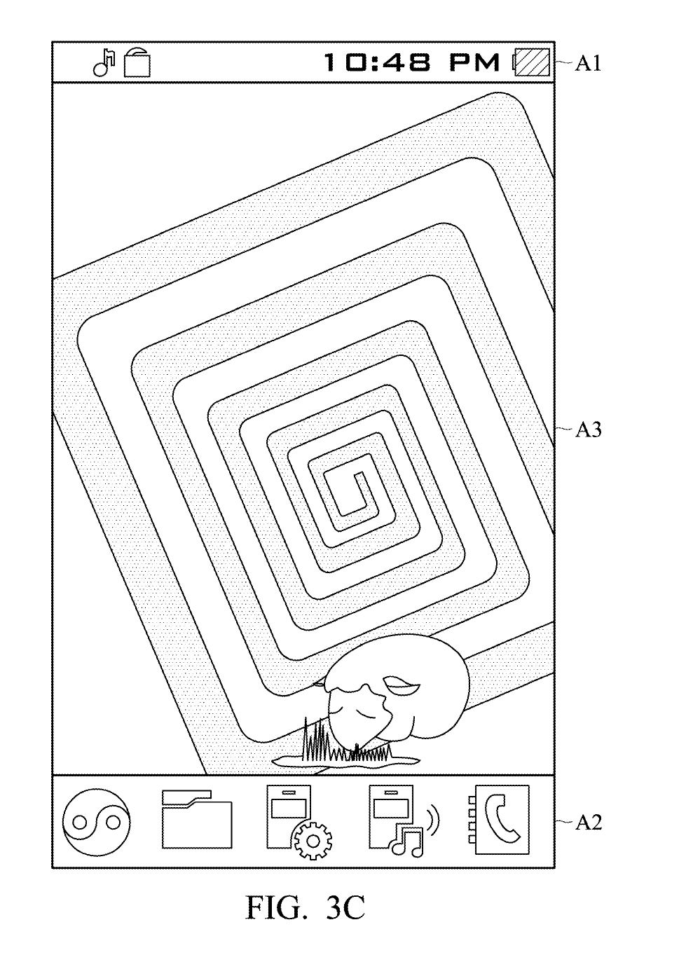

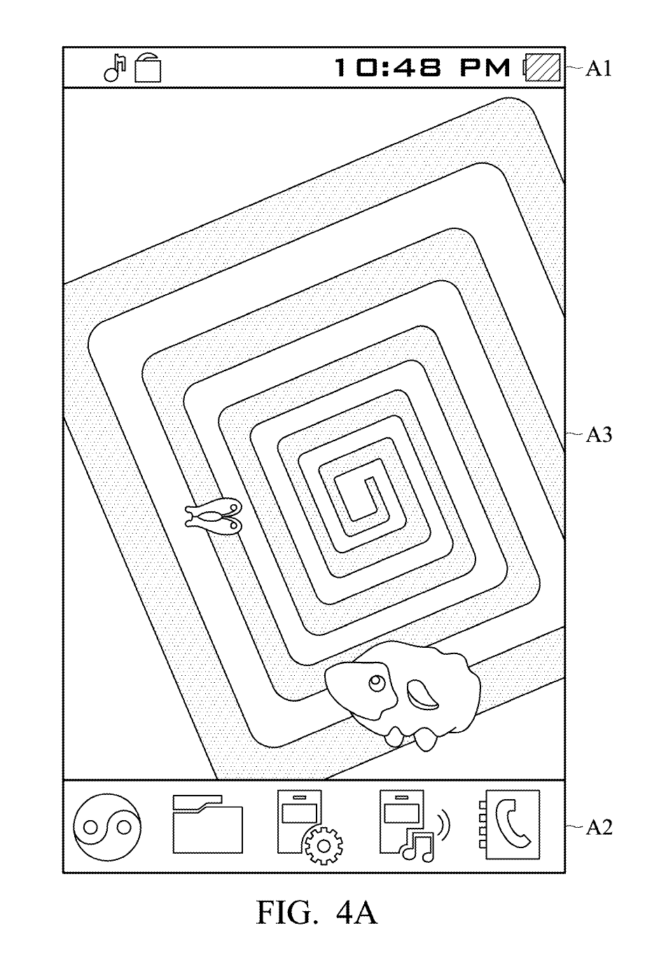

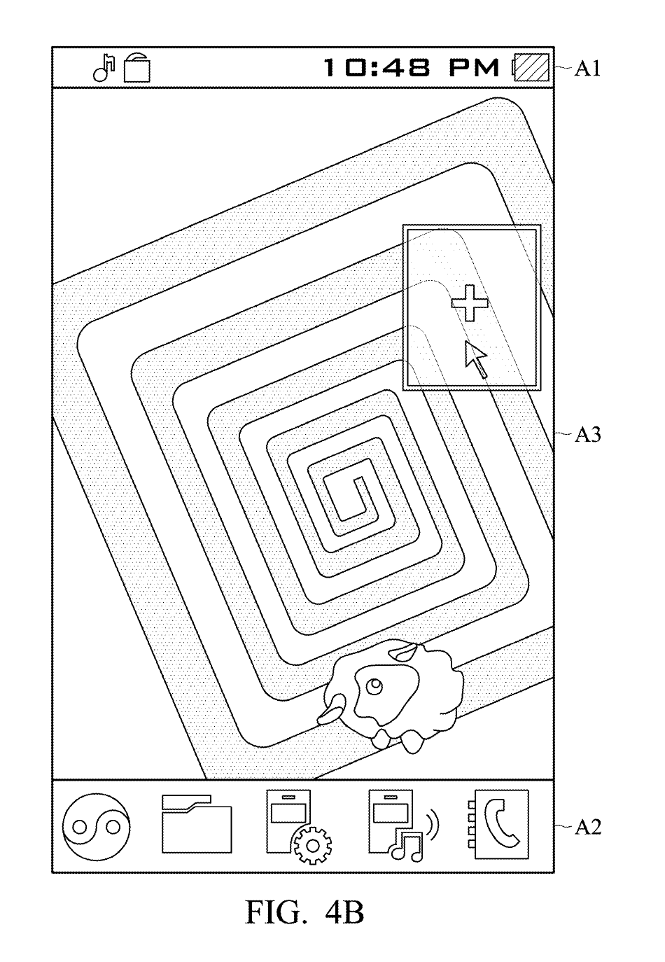

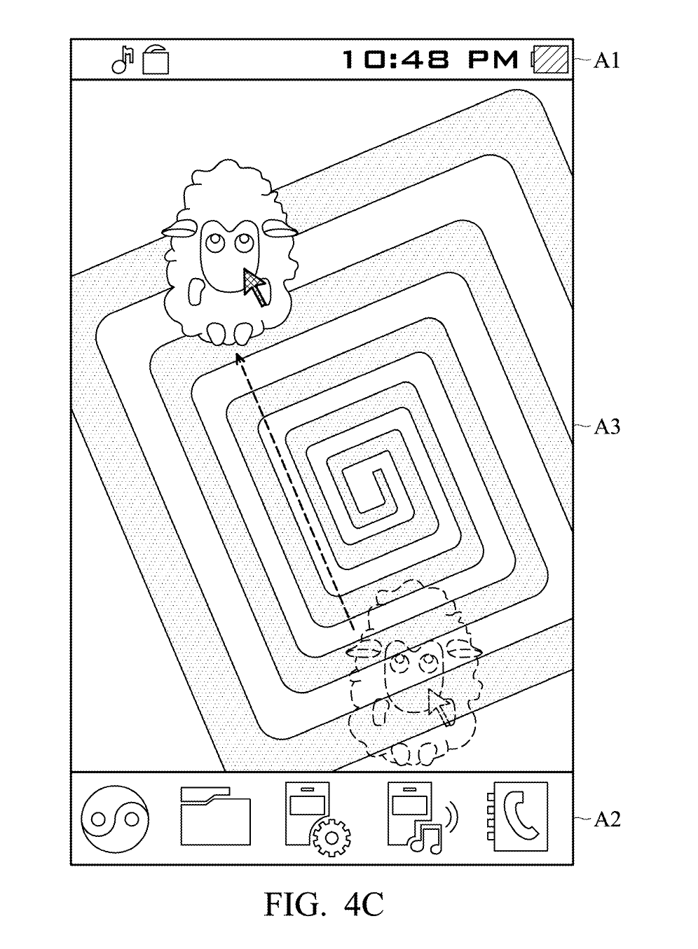

FIGS. 3A to 3C show exemplary displays on the touch screen 16 according to an embodiment of the invention. As shown in FIGS. 3A to 3C, the entire screen is partitioned into 3 areas. The area A2 displays the widget menu and/or application menu, in which contains multiple widget and/or application icons, prompting users to select a widget or application to use. A widget is a program that performs simple functions when executed, such as providing a weather report, stock quote, playing an animation on the touch screen 16, or others. The area A1 displays the system status, such as currently enabled functions, phone lock status, current time, remaining battery power, and so on. The area A3 displays the appearances of the widgets in use. The sheep in the area A3 is an animation generated by the widget 231, which shows specific actions of a sheep, such as standing still (as shown in FIG. 3A), rambling (as shown in FIG. 3B), eating grass (as shown in FIG. 3C), etc. The widget 231 may be created to draw the sheep in the area A3 when a corresponding widget icon in the area A2 is dragged and dropped into the area A3. FIGS. 4A to 4C show exemplary displays on the touch screen 16 according to an embodiment of the invention.

The entire screen is partitioned into 3 areas, i.e., the areas A1 to A3, as mentioned above. In addition to the animated sheep, there is an animation of a butterfly in the area A3 generated by the widget 232, which shows a random flying pattern of a butterfly. It is to be understood that the widget 232 may be created and initialized by the widget 231 or the control engine module 220. Since the widgets 231 and 232 are capable of interacting with each other, the widget 231 may further modify the displayed actions of the sheep in response to the position updates of the butterfly. Specifically, the widget 231 may change the action of the standing, rambling or eating sheep to turn its head towards the current position of the butterfly, as shown in FIG. 4A. Pseudo code for the case where the widget 231 periodically examines whether the widget 232 changes its position and acts on the changed position of the widget 232 is addressed below as an example:

```
Function Detect_OtherWidgets( );
{
  while (infinite loop)
  {
    get butterfly widget instance;
    if (butterfly is active)
    {
      use butterfly widget to get its position;
      get my widget position;
      change my widget orientation according to the arctan function of
the difference of butterfly position and my widget position;
    }
    if (stop detecting signal is received)
    {
      return;
    }
  }
}
```

Alternatively, the position updates of the animated butterfly generated by the widget 232 may actively triggers the modification of the animated sheep generated by the widget 231 via a subscribed event handler. Pseudo code for the case where the widget 231 changes its action when a position change event is triggered by the widget 232 is addressed below as an example:

```
function myButterflyPositionChangeHandler (butterfly position)
{
  get my widget position;
  change my widget orientation according to the arctan function of the
difference of butterfly position and my widget position;
}
```

In still another embodiment, the widget 231 may change the action of the standing, rambling or eating sheep to turn its head towards a position where the touch event occurred, as shown in FIG. 4B. Pseudo code for the case where the widget 231 acts on the touch event is addressed below as an example:

```
function DetectEvents( );
{
  while (infinite loop)
  {
    if (pen is active)
    {
      get my widget position;
      get active pen event type and position;
      if (pen type == down or move)
      {
        change my widget orientation according to the arctan function
of the difference of pen position and my widget position;
      }
    }
    if (stop dectecting signal is received)
    {
      return;
    }
  }
}
```

Alternatively, the mobile phone 10 may be designed to actively trigger the modification of the animated sheep generated by the widget 231 through a touch event handler. Pseudo code for the case where the widget 231 changes its action in response to the touch event is addressed below as an example:

```
function myPenEventHandler (pen type, pen position)
{
  get my widget position;
  change my widget orientation according to the arctan function of the
difference of pen position and my widget position;
}
```

It is noted that the position where the touch event occurred is not limited to be within area A3. The touch may be placed within area A1, or as well within area A2.

In addition, regarding the registrations of the widgets 231 and 232, and the touch event to the control engine module 220, exemplary pseudo code is addressed below:

```
function EventWidget_Register( )
{
  register pen event handler;
  get buttefly widget instance;
  if (butterfly is active);
  {
    use butterfly widget to register its position change handler;
  }
}
```

The touch event may indicate a contact of an object on the touch screen 16 in general. The touch event may specifically indicate one of a click event, a tap event, a double-click event, a long-press event, a drag event, etc., or the touch event may be referred to as a sensed approximation of an object to the touch screen 16, and is not limited thereto. The currently detected touch event may be kept by the control engine module 220. The widget 231 or 232 may request the control engine 220 for touch event information to determine whether a particular touch event kind is detected and a specific position of the detected touch event. A click event or tap event may be defined as a single touch of an object on the touch screen 16. To further clarify, a click event or tap event is a contact of an object on the touch screen 16 for a predetermined duration or for object-oriented programming terminology, a click event or tap event may be defined as a “keydown” event instantly followed by a “keyup” event. The double-click event may be defined as two touches spaced within a short interval. The short interval is normally derived from the human perceptual sense of continuousness, or is predetermined by user preferences. The long-press event may be defined as a touch that continues over a predetermined time period. With the sensor(s) placed in a row or column on or under the touch screen 16, the drag event may be defined as multiple touches by an object starting with one end of the sensor(s) and ending with the other end of the sensor(s), where any two successive touches are within a predetermined time period. Particularly, the dragging may be in any direction, such as upward, downward, leftward, rightward, clockwise, counterclockwise, or others. Taking the drag event for example, the animation of the sheep generated by the widget 231 may be shifted from one position to another by a drag event. As shown in FIG. 4C, the sheep appears to be lifted up from its original position when the “keydown” of a drag event occurs upon it, and then the sheep is attached to where the pointer moves on the touch screen 16, i.e., the sheep is moved with the pointer. Later, when the “keyup” of the drag event occurs, the sheep is dropped below the current position of the pointer. Likewise, the animation of the butterfly generated by the widget 232 may be shifted by a drag event as well. The touch object may be a pen, a pointer, a stylus, a finger, etc.

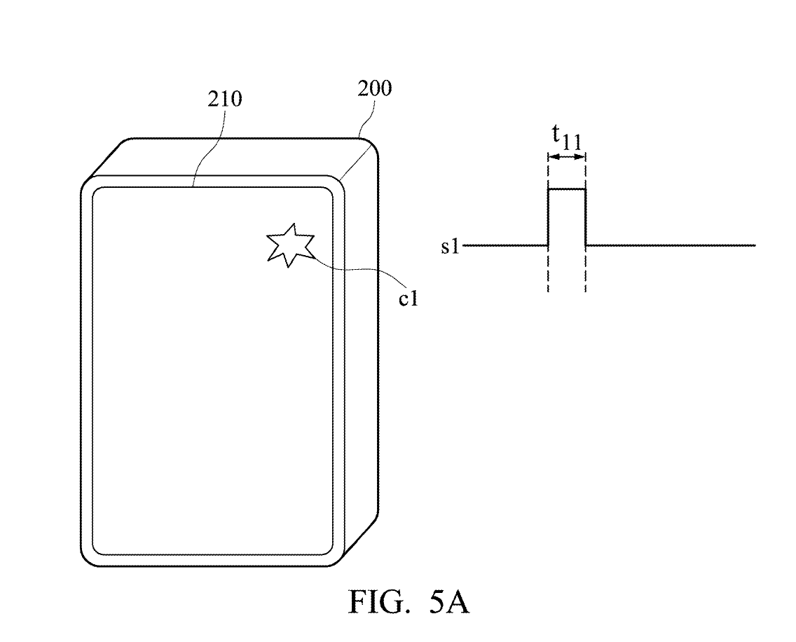

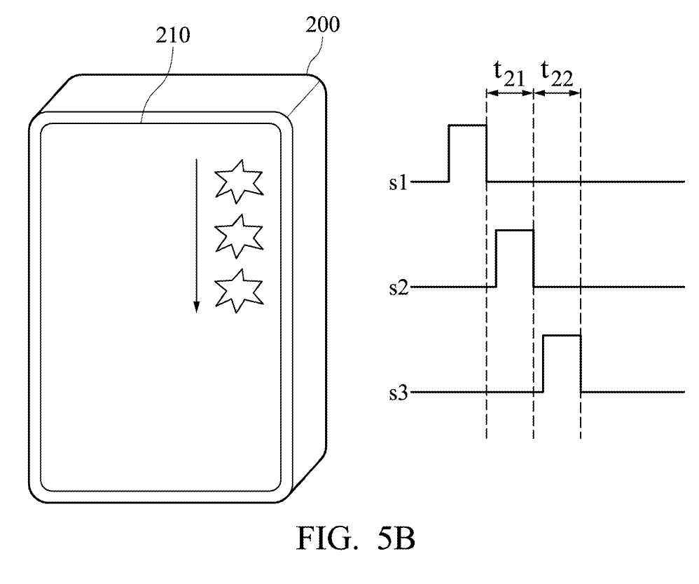

FIG. 5A shows a schematic diagram of a click event with a signal s1 on the touch screen 16 according to an embodiment of the invention. The signal s1 represents the logic level of the click event cl detected by the sensor(s) (not shown) disposed on or under the touch screen 16. The signal s1 jumps from a low logic level to a high logic level in the time period t₁₁ which starts in the time when a “keydown” event is detected and ends in the time when a “keyup” event is detected. Otherwise, the signal S1 remains in the low logic level. A successful click event is further determined with an additional limitation that the time period t₁₁ should be limited within a predetermined time interval. FIG. 5B shows a schematic diagram of a drag event with signals s2 to s4 on the touch screen 16 according to an embodiment of the invention. The signals s2 to s4 represent three continuous touches detected in sequence by the sensor(s) (not shown) disposed on or under the touch screen 16. The time interval t₂₁ between the termination of the first and second touches, and the time interval t2₂ between the termination of the second and third touches are obtained by detecting the changes of the logic levels. A successful drag event is further determined with an additional limitation that each of time intervals t₂₁ and t₂₂ is limited within a predetermined time interval. Although placed in a linear track in this embodiment, the continuous touches may also be placed in a non-linear track in other embodiments.

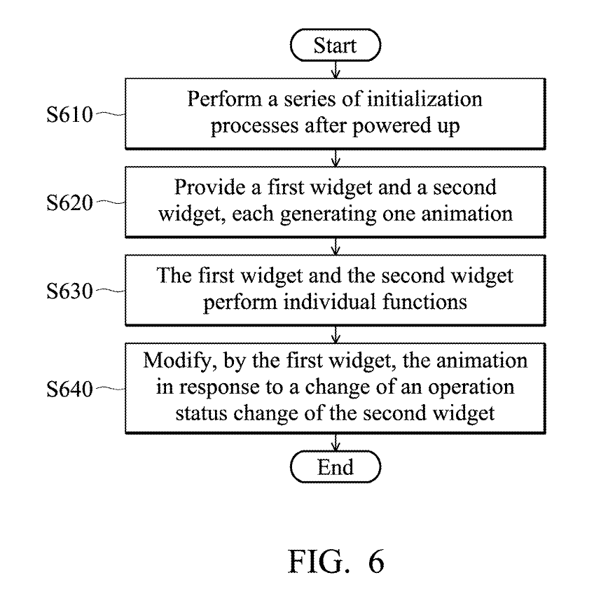

It is noted that the interactions between the widgets, i.e., the widgets 231 and 232, are specifically provided in visually perceivable presentations on the touch screen 16 to increase user interests of the applications provided by the mobile phone 10. Also, the visually perceivable interactions between the widgets may provide the users with a more efficient way of operating different widgets. In one embodiment, the figures of the animations generated by the widgets 231 and 232 are not limited to a sheep and a butterfly, they may be animations showing actions of other creatures or iconic characters, such as the SpongeBob, WALL-E, and Elmo, etc. In another embodiment, the widget 231 may be designed to modify a color or a facial expression, instead of modifying actions, of the sheep in response to the touch event or the operating status change of the widget 232. For example, the color of the sheep may be changed from white to brown or any other color or the expression of the sheep may be changed from a poker face to a big smile, when detecting an occurrence of a touch event on the touch screen 16 or the operating status change of the widget 232. Alternatively, the widget 231 may be designed to emulate a dog or any other animals in response to the touch event or the operating status change of the widget 232. FIG. 6 is a flow chart illustrating the real time interaction method for the mobile phone 10 according to an embodiment of the invention. To begin, when the mobile phone 10 is started up, a series of initialization processes, including booting up of the operating system, initializing of the control engine module 220, and activating of the embedded or coupled functional modules (such as the touch screen 16), etc., are performed (step S610). After the control engine module 220 is initialized and ready, the widgets 231 (also referred to as a first widget in the drawing) and 232 (also referred to as a second widget in the drawing) may be created and initialized via the control engine module 220 in response to user operations (step S620), wherein each widget is associated with a particular function. In the embodiment, the widget 231 is associated with an animation showing the actions of a sheep, and the widget 232 is associated with an animation showing the actions of a butterfly, as shown in FIG. 4A. The widget 231 may be created and initialized when the control engine module 220 detects that a corresponding widget icon is dragged from the area A2 and dropped into the area A3 by a user while the widget 232 may be randomly created and initialized by the control engine module 220. Or, the widget 232 may be created and initialized by the widget 231. As the widgets 231 232 are being created and executed, the first widgets 231 and 232 perform individual functions (step S630). For example, the widget 231 may generate the animation of a sheep with default movements, such as rambling, and the widget 232 may generate the animation of the butterfly with default movements, such as flying around. Subsequently, the first widget 231 modifies the animation in response to a operating status change of the widget 232 (step S640). Specifically, a change of the operating status of the widget 232 may refer to the position update of the animated butterfly, and the animation modification of the widget 231 may refer to the sheep turning its head and looking toward the position of the butterfly, as shown in FIG. 4A. Note that the modification of the animation may be a recurring step for the widget 231 in response to the latest operating status change of the widget 232. In some embodiments, the animation generated by the widgets 231 and 232 may emulate actions and movements of other creatures or iconic characters.

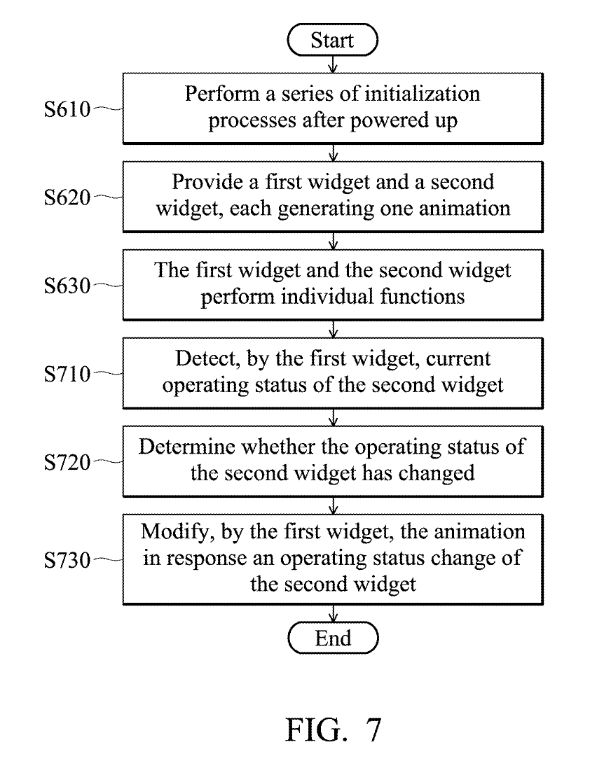

FIG. 7 is a flow chart illustrating another embodiment of the real time interaction method. Similar to the steps S610 to S630 in FIG. 6, a series of initialization processes are performed when the mobile phone 10 is started up, and the widgets 231 and 232 are created and initialized via the control engine module 220 to execute individual functions. Subsequently, the widget 231 actively detects a current operating status of the widget 232 (step 710) and determining whether the operating status of the widget 232 has changed (step 720). Step 710 may be accomplished by requesting the control engine module 220 for the operating status information, using a corresponding function provided by the widget 232 or retrieving a corresponding property of the widget 232. Step 720 may be accomplished by comparing the current operating status with the last detected one. In response to the detected changed operating status of the widget 232, the widget 231 modifies the animation (step S730). It is noted that the determination of a changed operating status of the widget 232 and subsequent animation modification may be recurring steps performed by the widget 231. That is, the steps 710 to 730 are periodically performed to modify the animation if required. Alternatively, the detection of a potential operating status change of the widget 232 may be continued after a predetermined time interval since the last detection. That is, each time period, in which the widget 231 may generate an animation showing the rambling sheep, is followed by a detection time period, in which the widget 231 performs the steps S710 to S730 in a periodicity manner. When detecting an operating status change of the widget 232, the first widget 231 may modify the animation to stop rambling and turn the sheep's head toward the current position of the butterfly. Otherwise, when detecting no change for the widget 232, the widget 231 may modify the animation to stop rambling and to eat grass.

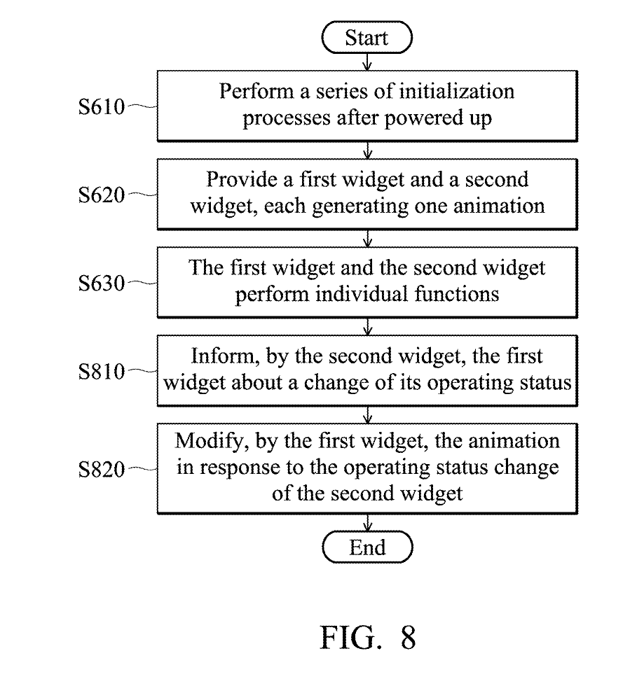

FIG. 8 is a flow chart illustrating still another embodiment of the real time interaction method. Similar to the steps S610 to S630 in FIG. 6, a series of initialization processes are performed when the mobile phone 10 is started up, and the widgets 231 and 232 are created and initialized via the control engine module 220 to perform their own behaviors. Subsequently, the widget 232 actively inform the widget 231 about a change of its operating status (step S810), so that the widget 231 may modify the animation in response to the changed operating status of the widget 232 (step S820). It is noted that the informing of the changed operating status of the widget 232 may be a recurring step for the widgets 231. That is, in response to the changed operating statuses repeatedly informed by the widget 232, the widget 231 continuously modifies the animation.

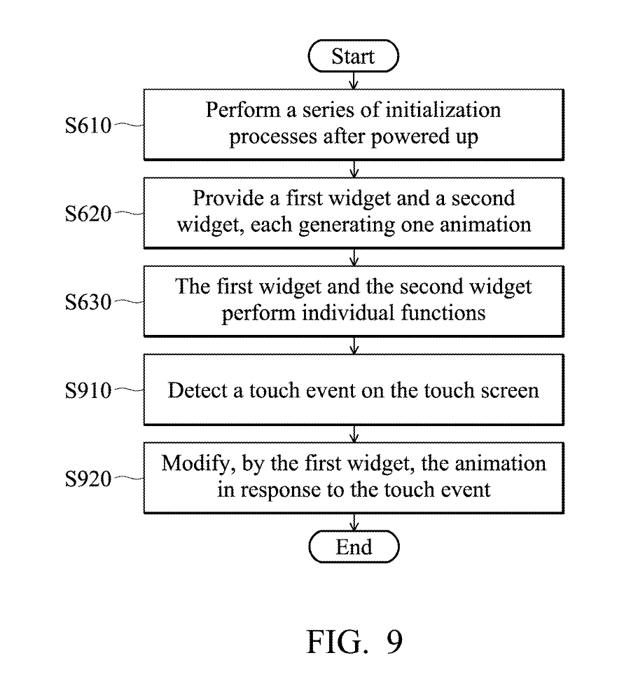

FIG. 9 is a flow chart illustrating the real time interaction method for the mobile phone 10 according to still another embodiment of the invention. Similar to the steps S610 to S630 in FIG. 6, a series of initialization processes are performed when the mobile phone 10 is started up, and the widget 231 and the widget 232 are created and initialized via the control engine module 220 to perform their own behaviors. One or more sensors (not shown) are disposed on or under the touch screen 16 for detecting touch events thereon. A touch event may refer to a contact of an object on the touch screen 16, or it may also refer to a sensed approximation of an object to the touch screen 16. Subsequently, a touch event is detected on the touch screen 16 (step S910). In response to the touch event, the widget 231 modifies the animation (step S920). Specifically, the detected touch event may refer to a click event, a tap event, a double-click event, a long-press event, or a drag event, and the animation modification by the widget 231 may refer to that the sheep turns its head and looks to the position where the touch event occurred, as shown in FIG. 4B. In some embodiments, the widget 231 may modify a color or a facial expression, instead of modifying the animation, of the sheep in response to the touch event. Alternatively, the widget 231 may modify the figure of the animation from a sheep to a dog or any other animals in response to the touch event.

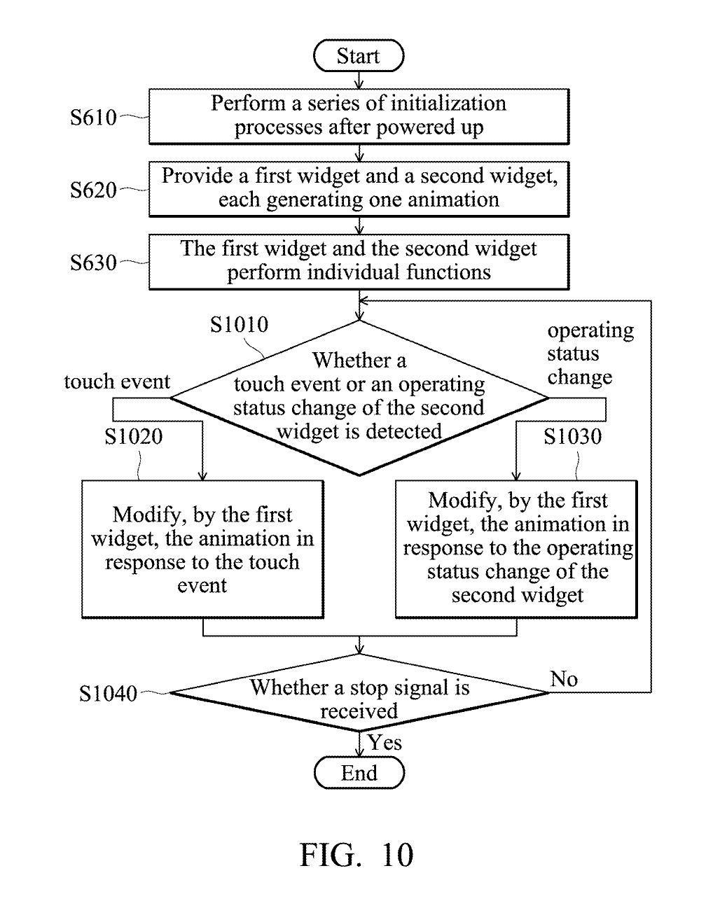

FIG. 10 is a flow chart illustrating the real time interaction method for the mobile phone 10 according to still another embodiment of the invention. Similar to the steps S610 to S630 in FIG. 6, a series of initialization processes are performed when the mobile phone 10 is started up, and the widgets 231 and 232 are created and initialized via the control engine module 220 to perform their own behaviors. The touch screen 16 is capable of detecting touch events thereon. Subsequent to step S630, the widget 231 determines whether a touch event or an operating status change of the widget 232 is detected (step S1010). If a touch event is detected on the touch screen 16, the widget 231 modifies its own animation according to the touch event (step S1020). If a change of the operating status of the widget 232 is detected, the widget 231 modifies the animation according to the changed operating status of the widget 232 (step S1030). After that, it is determined whether a stop signal is received (step S1040). If so, the process ends; if not, the flow of the process goes back to step S1010 to detect a next touch event or a next change of the operating status of the widget 232. Although the detections of the touch event and the changed operating status of the widget 232 are determined in a single step, the real time interaction method may alternatively be designed to have the detections of the touch event and the changed operating status of the widget 232 to be performed in two separate steps in sequence. Note that the process of the real time interaction method may be ended when the widget 231 is terminated or is dragged from the area A3 and dropped into area A2.

While the invention has been described by way of example and in terms of preferred embodiment, it is to be understood that the invention is not limited thereto. Those who are skilled in this technology can still make various alterations and modifications without departing from the scope and spirit of this invention. It is noted that the widgets 231 232 may be designed to provide different functions other than the animations of the sheep and butterfly. For example, the widget 231 may generate a schedule listing daily tasks inputted by a user, the widget 232 may generate a calendar displaying months and days, and the widget 231 may display tasks in a specific week or on a specific day in response to the selected month and day of the widget 232. In addition, the real time interaction method or system may provide interaction among more than two widgets, and the invention is not limited thereto. Therefore, the scope of the present invention shall be defined and protected by the following claims and their equivalents.

What is claimed is:

1. An electronic interaction apparatus, comprising:
a touch screen;
a processing unit executing a first widget and a second widget, wherein the first widget generates an animation on the touch screen, and modifies the animation in response to an operating status change of the second widget.

2. The electronic interaction apparatus of claim 1, wherein the processing unit further executes a control engine module, and the first widget further requests information concerning a current operating status of the second widget from the control engine module, determines whether the operating status change of the second widget has occurred, and modifies the animation according to the current operating status of the second widget when the operating status change has occurred.

3. The electronic interaction apparatus of claim 1, wherein the first widget gets a current operating status of the second widget by invoking a function of the second widget or retrieving a property of the second widget, determines whether the operating status change of the second widget has occurred, and modifies the animation according to the current operating status of the second widget when the operating status change has occurred.

4. The electronic interaction apparatus of claim 1, wherein the first widget is informed by the second widget about the operating status change of the second widget, and modifies the animation according to a current operating status of the second widget.

5. The electronic interaction apparatus of claim 1, wherein the touch screen detects a touch event thereon, and the first widget further modifies the animation in response to the touch event.

6. The electronic interaction apparatus of claim 1, wherein the first widget modifies a head of a first animated animal to look toward a current position of a second animated animal generated by the second widget.

7. The electronic interaction apparatus of claim 1, wherein the touch screen is partitioned into a first area and a second area, and the first widget is executed when a corresponding widget icon in the first area is dragged and dropped into the second area.

8. The electronic interaction apparatus of claim 7, wherein the second widget is created and initiated by the first widget.

9. An electronic interaction apparatus, comprising:
a touch screen;
a processing unit detecting a touch event on the touch screen, and executing a widget, wherein the widget generates an animation on the touch screen, and modifies the animation in response to the touch event.

10. The electronic interaction apparatus of claim 9, wherein the processing unit executes a control engine module keeping touch event information being currently detected on the touch screen, and the widget requests the control engine module for the touch event information.

11. The electronic interaction apparatus of claim 9, wherein the widget modifies a head of an animated animal to took toward a current position of the touch event.

12. The electronic interaction apparatus of claim 9, wherein the touch screen is partitioned into a first area and a second area, and the widget is executed when a corresponding widget icon in the first area is dragged and dropped into the second area.

13. A real time interaction method executed in an electronic apparatus with a touch screen, comprising:
executing a first widget and a second widget, wherein the first widget generates an appearance on the touch screen; and
modifying, by the first widget, the appearance in response to an operating status change of the second widget.

14. The real time interaction method of claim 13, wherein the first widget modifies a color of an animation in response to the operating status change of the second widget.

15. The real time interaction method of claim 13, wherein the first widget modifies a facial expression of an animation in response to the operating status change of the second widget.

16. The real time interaction method of claim 13, wherein the first widget generates an animation showing a standing, rambling or eating animal when detecting no operating status change of the second widget.

17. A real time interaction method for an electronic apparatus with a touch screen, comprising:
executing a widget generating an appearance on the touch screen;
detecting a touch event on the touch screen; and
modifying, by the first widget, the appearance in response to the touch event.

18. The real time interaction method of claim 17, wherein the widget modifies a color of an animation in response to the detected touch event.

19. The real time interaction method of claim 17, wherein the widget modifies a facial expression of an animation in response to the touch event.

20. The real time interaction method of claim 17, wherein the widget generates an animation showing a standing, rambling or eating animal when detecting no touch event on the touch screen.
